(19) United States
(12) Patent Application Publication
(10) Pub. No.: US 2014/0244363 A1
(43) Pub. Date: Aug. 28, 2014

(54) PUBLICATION OF INFORMATION REGARDING THE QUALITY OF A VIRTUAL MEETING

(71) Applicant: INTERNATIONAL BUSINESS MACHINES CORPORATION, Armonk, NY (US)

(72) Inventors: Amy D. Travis, Arlington, MA (US); Stephen J. Foley, Quincy, MA (US)

(73) Assignee: International Business Machines Corporation, Armonk, NY (US)

(21) Appl. No.: 13/781,044

(22) Filed: Feb. 28, 2013

(51) Int. Cl. G06Q 10/06

(52) U.S. Cl. CPC G06Q 10/06393
USPC 705/7.39

(57) ABSTRACT

Arrangements relate to the publication of information regarding the quality of a virtual meeting. One or more performance indicators related to an aspect of the meeting can be collected. The performance indicators can be collected automatically or by input by a meeting attendee. The collected performance indicators can be aggregated. The aggregated performance indicators can be published to an external computing system, such as a social collaboration system.

### BACKGROUND

Arrangements described herein relate to tracking and publishing information regarding the quality of one or more aspects of a virtual meeting.

Advances in communications and information technology have allowed for greater collaboration and streamlined processes within an organization. As a result, the need for an individual's physical presence has been reduced in at least some situations. For instance, meetings between two or more individuals are a regular part of any organizational environment. When meeting participants are located in different locations, an in-person meeting may not be practical. Instead, a meeting can be conducted virtually such that the two or more participants interact with one another remotely. Examples of ways in which virtual meetings can occur include teleconferences, web-conferencing, or online collaboration, instant messaging, video conferencing, voice conferencing, desktop/computer sharing.

An effective meeting is facilitated by good presenters and/or meeting chairs. However, it may be difficult to identify those individuals within an organization who are regarded as good meeting presenters or chairs. Such information is typically passed by word-of-mouth, but this approach is inexact and the information is susceptible being lost or limited in its dissemination.

### BRIEF SUMMARY

One or more embodiments disclosed within this specification relate to the quality of virtual meetings and, more particularly, to the publication of information regarding the quality of a virtual meeting.

An embodiment can include a method of publishing information regarding the quality of a virtual meeting. The method can include collecting one or more performance indicators related to an aspect of the meeting. The method can further include aggregating the collected performance indicators. The method can also include publishing the aggregated performance indicators to an external computing system.

Another embodiment can include a system of publishing information regarding the quality of a virtual meeting. The system comprising can include a processor programmed to initiate executable operations. The executable operations can include collecting one or more performance indicators related to an aspect of the virtual meeting. The executable operations can further include aggregating the collected performance indicators. The executable operations can include publishing the aggregated performance indicators to an external computing system.

Another embodiment can include a computer program product for publishing information regarding the quality of a virtual meeting. The computer program product can include a computer-readable storage medium having stored thereon program code that, when executed, configures a processor to perform a method. The method can include collecting, by the processor, one or more performance indicators related to an aspect of the virtual meeting. The method can further include aggregating, by the processor, the collected performance indicators. The method can include publishing the aggregated performance indicators to an external computing system.

### BRIEF DESCRIPTION OF THE SEVERAL VIEWS OF THE DRAWINGS

FIG. 1 is a block diagram illustrating a system for tracking and publishing information regarding the quality of one or more aspects of a virtual meeting in accordance with one embodiment disclosed within this specification.

FIG. 2 is a flow chart illustrating a method of tracking and publishing information regarding the quality of one or more aspects of a virtual meeting in accordance with one embodiment disclosed within this specification.

FIG. 3 is a block diagram illustrating a system for tracking and publishing information regarding the quality of one or more aspects of a virtual meeting in accordance with one embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

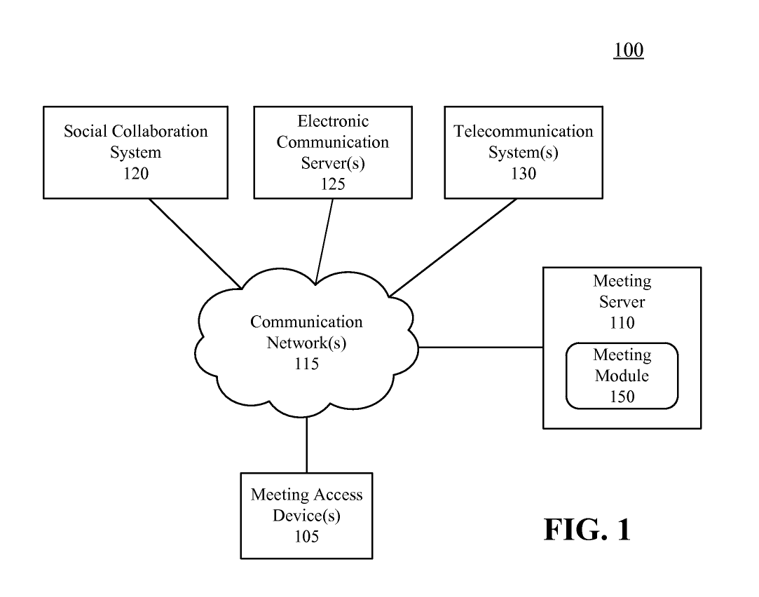

FIG. 1 depicts a block diagram illustrating a system 100 for tracking and publishing quality indicators of one or more aspects of a virtual meeting in accordance with one embodiment disclosed within this specification. It should be noted that the virtual meeting can be a virtual environment in which two or more virtually represented attendees (e.g. persons) can communicate using a communication network. Examples of ways in which virtual meetings can occur include teleconferences, web-conferencing, or online collaboration, instant messaging, video conferencing, voice conferencing, desktop/computer sharing. The meeting attendees include the meeting chair(s), meeting presenter(s), and meeting participant(s). A meeting participant includes individuals who attend the meeting but do not contribute to the meeting. In the virtual meeting, two or more virtually represented attendees can communicate audio, video, graphics, images, data, file documents, texts, etc. A virtual meeting can be implemented for a meeting in which at least some of the attendees are physically located within the same location, room, or meeting place.

In some instances, a virtual meeting can be implemented for a meeting in which at least at least some of the meeting attendees are located remotely from each other, thereby allowing the meeting attendees to interact with one another remotely.

The system 100 can include one or more meeting access devices 105 used by one or more users. “Meeting access device” is any device by which a meeting attendee can access a virtual meeting. The one or more meeting access devices 105 can be any suitable device including, for example, a smart phone, a computer (e.g., a laptop, tablet, desktop, etc.), personal digital assistant (“PDA”), in-car hands free phone, a portable communication device, a portable computing device, etc. In some instances, the one or more meeting access devices 105 can be configured to communicate via a wireless and/or wired medium.

In at least some instances, one or more of the meeting access devices 105 can be an electronic communication server 125. The electronic communication server 125 can be implemented as, for example, an electronic mail system, an instant messaging (IM) system, a text messaging system, video conferencing system, or the like. In this regard, the electronic communication server 125 can be implemented as an electronic mail server, an instant messaging server, a text messaging server, a video conferencing server or other communication hub or server capable of routing electronic communications within or as part of the communication network 115. The electronic communication server 125 can include suitable operational software for performing the various functions described herein.

In at least some instances, one or more of the meeting access devices 105 can be a telecommunication system 130. The telecommunication system 130 can be implemented as, for example, a telephone system (e.g. Voice over Internet Protocol (VoIP) system), a voicemail system, a facsimile system, and the like. In this regard, the one or more telecommunication systems 130 can be implemented as a telephone server, a voicemail server, a facsimile server, or other communication hub or server capable of routing telecommunications within or as part of the communication network 115. The one or more telecommunication systems 130 can include suitable operational software for performing the various functions described herein. The telecommunication system 130 may support messaging.

The system 100 can include a meeting server 110, which can be communicatively linked to the one or more meeting access devices 105 via one or more communication networks 115. The meeting access devices also may be communicatively linked to one another via the one or more communication networks 115. As used herein, the term “communicatively linked” can include direct or indirect connections through a communication channel or pathway or another component or system. A “communication network” means one or more components designed to transmit information to and/or receive information from one source to another. The communication network 115 can include wired communication links and/or wireless communication links The communication network 115 can comprise the Internet, a wide area network (WAN), wireless wide area network (WWAN), a local area network (LAN), wireless local area network (WLAN), a wireless communication network, a mobile network, a Virtual Private Network (VPN), the Internet, the Public Switched Telephone Network (PSTN), and/or the like. The communication network 115 can include any combination of the above networks and/or other types of networks. The network can include one or more routers, switches, access points, wireless access points, and/or the like.

The one or more electronic communication servers 125 can be communicatively linked to the meeting server 110 and/or one or more other meeting access devices 105, such as by the communication network 115. The one or more telecommunication systems 130 can be communicatively linked to the one or more meeting access devices 105 and/or the meeting server 110, such as by the communication network 115.

The system 100 can include one or more social collaboration systems 120. “Social collaboration system” as used herein refers to web-based technologies used to turn communication into interactive dialogue between organizations, communities, and individuals. Examples of social collaboration systems include, for example, social networking websites, collaborative projects, blogs and micro blogs, content communities, discussion forums, wikis, intranets, or a website. The one or more social collaboration systems 120 can be communicatively linked to the one or more meeting access devices 105 and/or the meeting server 110.

The system 100 can include a meeting module 150. In one embodiment, the meeting module 150 can be stored and/or executed on the one or more meeting access devices 105. Alternatively or in addition, the meeting module 150 can be stored and/or executed on the meeting server 110. As a further implementation, which can be as an alternative or in addition to the above, the meeting module 150 can be stored and/or executed on the one or more social collaboration systems 120, the one or more electronic communication servers 125 and/or the one or more telecommunication systems 130.

The meeting module 150 can facilitate the conducting of a virtual meeting in various ways. For instance, the meeting module 150 can start, conduct, and termination the session. The meeting module 150 process data to identify attendees, data related to a presentation within the virtual meeting, data related to a meeting topic within the virtual meeting, a need for a virtual meeting, provide agenda tracking, determining whether an meeting attendee's window is in focus on the meeting and/or devices used by attendees to communicate with the virtual meeting. The meeting module 150 can provide automated data archiving, capture during the virtual meeting that can track virtual meeting minutes. The meeting module 150 can allow users to participate in the meeting via any suitable means, including messaging (e.g. instant messaging), video and/or audio channels.

The virtual meeting module can collect one or more performance indicators regarding an aspect of the meeting. A “performance indicator” is defined as an expression, determination or measurement of an aspect of a virtual meeting. In at least some instances, the performance indicator can be a qualitative metric. The performance indicator can be an objective measurement (e.g. did the meeting start on time?), or it can be subjective (e.g. an expression of a meeting attendee's impressions of an aspect of the meeting).

The performance indicator can be made with respect to one or more aspects of the virtual meeting. For instance, the performance indicators can be made with respect to any suitable aspect about the virtual meeting itself, the meeting attendees (e.g. the chair(s), the presenter(s), participant(s) and/or attendee(s)), meeting content (e.g., slide, visual, or demonstration), etc.

Examples of performance indicators can include: whether the meeting started on time, whether the meeting ended on time, whether the meeting kept pace with the agenda, whether the meeting stayed on track with the agenda, the quantity of, percentage of, or frequency at which the meeting windows of meeting attendees were in focus during the meeting.

Further examples of performance indicators can be: the rating of the virtual meeting as a whole, the rating of the meeting chair, the rating of meeting speakers, the rating of individual presentations or a subset of a presentation (e.g. a particular slide, visual or demonstration). Still further examples of performance indicators include: whether the individual was on time for the meeting, whether the individual left the meeting early, the amount or percentage of time that the individual's virtual meeting window was in focus during the meeting, the number of questions that the meeting participant asked, the whether a meeting participant contributed during the meeting (e.g., speaking and/or questions, etc.).

The performance indicator can have any suitable form. In one implementation, the performance indicator can be a single expression. For instance, the performance indicator can be a favorable expression (e.g., like, thumbs-up, applause, etc.) that a user can indicate his or her approval. Alternatively or in addition, the performance indicator can be a negative expression or a neutral expression. In some embodiments, the performance indicator can be a plurality of predetermined choices that an individual can select from. Further, the performance indicator can be a free-form input by a meeting attendee. For instance, it could be a numerical value (e.g., ranging from 10 for excellent to 1 for poor) or it could be a word input by the meeting attendee. The performance indicator can be a measurement of the frequency at which meeting attendees indicate a favorable impression of an aspect of the virtual meeting during the presentation or the percentage of attendees that indicate a favorable impression of an aspect of the virtual meeting.

The meeting module can be used to collect one of more performance indicators from the meeting participants or other source. The performance indicator can be collected by the meeting module in various ways. For instance, the system can receive performance indicators by inputs received from meeting attendees. Accordingly, the meeting access device 105 can present an input system for receiving user inputs. Any suitable input system can be used, including, for example, a keypad, display, touch screen, button, joystick, mouse, trackball, microphone or combinations thereof. In one implementation, a user interface can be provided to the meeting participant allowing them to indicate their feelings. A “user interface” is defined as a component, system or arrangement or groups thereof that enable a user to enter information/data into a machine. The interfaces can include one or more user interface elements, which can include one or more graphical user interface elements. A “user interface element” is defined as a component or a group of components that enables a user to interact with a machine. The term “graphical user interface element” is defined as an image or a portion of an image that presents information to a user or allows the user to interact with a device through a display. As an example, one or more user interface elements, such as graphical user interface elements (e.g. buttons) can be presented to the meeting participants to express favorability/applause/like. In such case, a meeting participant can select if he or she wishes to out of his or her own initiative. Further, the meeting module 150 can be configured to analyze the content of real-time conversations associated with the meeting (e.g. the text of instant messages, audio, audio converted to text, video, etc.) to detect performance indicators. If a performance indicator is detected, then it can be collected by the meeting module 150.

Alternatively or in addition, the meeting module 150 can be configured to prompt meeting participants to indicate their performance indicators. Still further, the system can collect performance indicators automatically. Some metrics can be detected automatically without any input from a meeting attendee. For instance, the meeting module 150 can detect whether meeting attendees are staying focus on the content being presented in the meeting. For instance, the meeting module 150 can detect the percentage of time the meeting room is in focus on an attendee's access device 105.

The meeting module can be configured to aggregate the collected performance indicators. “Aggregate” is intended to mean any manipulation of the collected performance indicators, including mathematical, statistical or other analysis or operations. Examples include summation, percentages, averages, frequency, etc.

The collected performance indicators, the aggregated performance indicators and/or a measurement of quality based on the aggregated performance indicators can be published to an external computing system. “External computing system” is any computing system that is external to and/or independent of the virtual meeting. Examples of external computing systems include a social collaboration system (e.g. social collaboration system 120). In this way, the information collected can be effectively disseminated to individuals beyond those who attended the virtual meeting.

“Published” means that the information is made accessible to individuals who were not meeting attendees. As an example, on a meeting presenter's page of a social media website, the meeting module 150 can publish the number of people who indicated favorable impressions during the presentation (e.g. “24 people applauded during your presentation on business networking.”). Publication can include the use of the performance indicators to influence a quality metric associated with one or more aspects of the virtual meeting (e.g., a presentation). For instance, collected performance indicators and/or the aggregated performance indicators can be used to add additional favorability indicators (e.g., “thumbs-up” or “likes”) associated with an aspect of the virtual meeting on the external computing system.

Embodiments herein can also include an associated incentive system. For instance, if an aspect of a meeting achieves a predetermined quantity or percentage of favorable performance indicators, then a virtual award, such as a badge or tag can be awarded. As an example, the badge can be “Highly Rated Speaker” or “Effective Meeting Chair.” The badge or tag can be posted on the social media page of the attendee who earned it. In this way, meeting chairs and presenters can be rated by their peers, and meeting chairs and presenters can receive feedback about their own performance. By providing incentives, it may incentivize meeting chairs and presenters to improve their performance.

Further, the meeting module 150 can be configured to provide additional points or increase favorable performance indicators if certain metrics are achieved. For instance, additional points could be gained by a meeting attendee for keeping the online meeting window in focus throughout the meeting. Additional points can be gained by meeting presenters who start and end on time or who keep pace with a prescribed agenda.

Embodiments herein can provide numerous advantages. Generally, embodiments herein can facilitate the capture and/or dissemination of information concerning the quality of one or more aspects of a virtual meeting. Performance indicators collected during the meeting can be disseminated beyond the virtual meeting room environment itself such that the information is available to individuals beyond those who attended the virtual meeting. Thus, information about the efficacy of a presenter or presentation could be shared with members of a social collaboration system. Such information could be included as part of a tracking system for business managers. The information can facilitate the evaluation of an individual who is a member of a group of members. As an example, the individual can be a member of a business or other organization. It can also facilitate optimization and streamlining of processes and/or membership within an organization or other group. For instance, it can help to identify one or more individuals within an organization or other group who may be an expert on a particular subject. Such identification could be made by the number of times someone presents on a topic or contributes to a meeting (e.g. by questions and/or comments) on a topic. It can also help to identify suitable members of the organization or other group for a particular project based on their historical performance indicators.

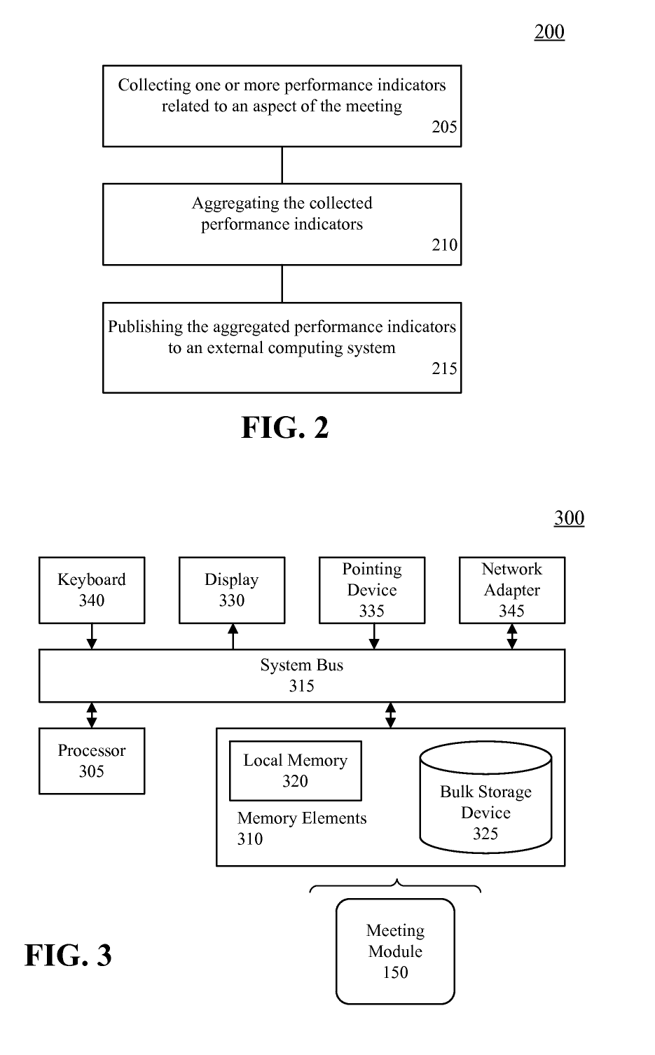

FIG. 2 is a flow chart illustrating a method 200 of publishing information regarding the quality of a virtual meeting in accordance with one embodiment disclosed within this specification. At step 205, one or more performance indicators related to an aspect of the meeting can be collected. At step 210, the collected performance indicators can be aggregated. At step 215, the aggregated performance indicators can be published to an external computing system.

FIG. 3 is a block diagram illustrating an example of a data processing system 300. System 300 can include at least one processor (e.g., a central processing unit) 305 coupled to memory elements 310 through a system bus 315 or other suitable circuitry. As such, system 300 can store program code within memory elements 310. Processor 305 executes the program code accessed from memory elements 310 via system bus 315 or the other suitable circuitry.

In one aspect, system 300 is implemented as a computer or other programmable data processing apparatus that is suitable for storing and/or executing program code. It should be appreciated, however, that system 300 can be implemented in the form of any system including a processor and memory that is capable of performing and/or initiating the functions and/or operations described within this specification. Further, system 300 can be implemented in any of a variety of different form factors including, but not limited to, a portable device such as a mobile communication device, a tablet computing and/or communication device, a laptop computing device, a desktop computing device, a server, or the like.

Memory elements 310 include one or more physical memory devices such as, for example, local memory 320 and one or more bulk storage devices 325. Local memory 320 refers to RAM or other non-persistent memory device(s) generally used during actual execution of the program code. Bulk storage device(s) 325 can be implemented as a hard disk drive (HDD), solid state drive (SSD), or other persistent data storage device. System 300 also can include one or more cache memories (not shown) that provide temporary storage of at least some program code in order to reduce the number of times program code must be retrieved from bulk storage device 325 during execution.

Input/output (I/O) devices such as a keyboard 340, a display 330, and a pointing device 335 optionally can be coupled to system 300. The I/O devices can be coupled to system 300 either directly or through intervening I/O controllers. One or more network adapters 345 also can be coupled to system 300 to enable system 300 to become coupled to other systems, computer systems, remote printers, and/or remote storage devices through intervening private or public networks. Modems, cable modems, wireless transceivers, and Ethernet cards are examples of different types of network adapters 345 that can be used with system 300.

As pictured in FIG. 3, memory elements 310 can store the meeting module 150. The meeting module 150, being implemented in the form of executable program code, is executed by system 300 and, as such, is considered an integrated part of system 300. The meeting module 150 can collect one or more performance indicators related to an aspect of the meeting, aggregate the collected performance indicators, and/or publish the aggregated performance indicators to an external computing system. Moreover, the meeting module 150, including any performance indicators, parameters and/or attributes utilized by module 150, are functional data structures that impart functionality when employed as part of system 300.

Each of the collected performance indicators, the aggregated performance indicators and/or a measurement of quality based on the aggregated performance indicators can be output to, and stored within, memory elements 310. As used herein, “outputting” and/or “output” can mean storing in memory elements 310, for example, writing to a file stored in memory elements 310, writing to display 330 or other peripheral output device, playing audible notifications, sending or transmitting to another system, exporting, or the like.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method of publishing information regarding the quality of a virtual meeting, the method comprising:
collecting one or more performance indicators related to an aspect of the meeting;
aggregating the collected performance indicators; and
publishing the aggregated performance indicators to an external computing system.

2. The method of claim 1, wherein the external computing system is a social collaboration system.

3. The method of claim 1, wherein the performance indicators are favorable performance indicators.

4. The method of claim 1, wherein collecting one or more performance indicators from one or more meeting attendees includes automatically the one or more performance indicators without input from one or more meeting attendees.

5. The method of claim 1, wherein collecting one or more performance indicators includes receiving one or more performance indicator inputs from one or more meeting attendees.

6. The method of claim 1, wherein publishing the aggregated performance indicators to an external computing system includes using the performance indicators to influence a quality metric for an aspect of the online meeting on the external computing system.

7. The method of claim 1, wherein publishing the aggregated performance indicators to an external computing system includes awarding a badge or tag associated with the aspect of the meeting on the external computing system if the aggregated performance indicators meet or exceed a predetermined threshold.

8. A system of publishing information regarding the quality of a virtual meeting, the system comprising:
a processor programmed to initiate executable operations comprising:
collecting one or more performance indicators related to an aspect of the meeting;
aggregating the collected performance indicators; and
publishing the aggregated performance indicators to an external computing system.

9. The system of claim 8, wherein the external computing system is a social collaboration system.

10. The system of claim 8, wherein the performance indicators are favorable performance indicators.

11. The system of claim 8, wherein collecting one or more performance indicators from one or more meeting attendees includes automatically the one or more performance indicators without input from one or more meeting attendees.

12. The system of claim 8, wherein collecting one or more performance indicators includes receiving one or more performance indicator inputs from one or more meeting attendees.

13. The system of claim 8, wherein publishing the aggregated performance indicators to an external computing system includes using the performance indicators to influence a quality metric for an aspect of the online meeting on the external computing system.

14. The system of claim 8, wherein publishing the aggregated performance indicators to an external computing system includes awarding a badge or tag associated with the aspect of the meeting on the external computing system if the aggregated performance indicators meet or exceed a predetermined threshold.

15. A computer program product for publishing information regarding the quality of a virtual meeting, the computer program product comprising a computer readable storage medium having program code stored thereon, the program code executable by a processor to perform a method comprising:
collecting, by the processor, one or more performance indicators related to an aspect of the meeting;
aggregating, by the processor, the collected performance indicators; and
publishing the aggregated performance indicators to an external computing system.

16. The computer program product of claim 15, wherein the external computing system is a social collaboration system.

17. The computer program product of claim 15, wherein collecting one or more performance indicators from one or more meeting attendees includes automatically the one or more performance indicators without input from one or more meeting attendees.

18. The computer program product of claim 15, wherein collecting one or more performance indicators includes receiving one or more performance indicator inputs from one or more meeting attendees.

19. The computer program product of claim 15, wherein publishing the aggregated performance indicators to an external computing system includes using the performance indicators to influence a quality metric for an aspect of the online meeting on the external computing system.

20. The computer program product of claim 15, wherein publishing the aggregated performance indicators to an external computing system includes awarding a badge or tag associated with the aspect of the meeting on the external computing system if the aggregated performance indicators meet or exceed a predetermined threshold.
